(19) United States
(12) Patent Application Publication
(10) Pub. No.: US 2024/0158556 A1
(43) Pub. Date: May 16, 2024

(54) STARCH HYBRID COPOLYMERS

(71) Applicant: Wacker Chemie AG, Munich (DE)

(72) Inventors: Stefan Haid, Mehring (DE); Thomas Lehotkay, Mühldorf (DE); Constantin Tiemeyer, Burghausen (DE)

(73) Assignee: Wacker Chemie AG, Munich (DE)

(21) Appl. No.: 18/284,303

(22) PCT Filed: Apr. 16, 2021
(86) PCT No.: PCT/EP2021/059882

§ 371 Date: Sep. 27, 2023

(51) Int. Cl. C08F 251/00; C08F 2/22; C08F 210/02; C08F 220/32; C08F 220/56; C08F 230/08; C08L 3/04; C09D 151/02; D01F 9/00; D06M 15/11

(52) U.S. Cl. CPC C08F 251/00; C08F 2/22; C08F 210/02; C08F 220/325; C08F 220/56; C08F 230/085; C08L 3/04; C09D 151/02; D01F 9/00; D06M 15/11; C08L 2201/54

(57) ABSTRACT

Starch hybrid copolymers in the form of aqueous dispersions or water-redispersible powders, processes for producing and uses for the same. Where the starch hybrid copolymers obtainable by radically initiated polymerization in aqueous medium of ethylenically unsaturated monomers in the presence of starch or by emulsion polymerization, in aqueous medium of ethylenically unsaturated monomers in the presence of starch. The starch hybrid copolymers may also be obtainable by performing an optional subsequent drying process.

The invention relates to starch hybrid copolymers in the form of aqueous dispersions or water-redispersable powders, to processes for producing them and to their use more particularly in coating compositions, such as paints and renders, or for producing fibres and fabrics.

Efforts are increasingly being made, for environmental reasons, to advance the substitution of petrochemical polymers by natural, renewable raw materials, such as starch. While the intention is as far as possible not to detract from the performance properties of the application products, this intention is generally not realized with mere physical blends of starch and polymers. Even with starch hybrid copolymers there are problems in achieving the requisite profile of properties. Starch hybrid copolymers are based on polymers of ethylenically unsaturated monomers and starch, which may be linked to one another via chemical bonds, for example, or bonded to one another in some other way.

A particular challenge is to attain the requisite mechanical strengths with starch-containing products, including particularly mechanical strengths after water storage of the application products, as specifically required in cases including that of polymer-bound fabrics, paints or renders. Hence in the case of coatings, such as paints, an important factor are high abrasion resistances, such as wet abrasion resistances, and with fabrics the demand is for high tensile bond strengths, more particularly high wet tensile strengths, or laundering durability.

Another problem arises from the fact that starch and petrochemical polymers have entirely different chemical structures. Accordingly, when starch is substituted for petrochemical polymers in established formulations, there may be instances of incompatibility and separation of the different substances, to the massive detriment of the profile of properties of the application products. Starch, therefore, must form stable mixtures with the other constituents of the formulation.

Various approaches to the production of starch hybrid copolymers are already known. Hence KR101473916B1 describes starch-based polymer particles of core-shell structure, which are obtained by polymerizing hard and soft monomers in the presence of starch degradation products initially to form the core, onto which hard, soft and silane monomers are then polymerized as the shell. Homopolymers of the soft monomers of KR101473916B1 have a glass transition temperature of 10° C. to −80° C. Ethylene homopolymers, in contrast, have a glass transition temperature of −85° C.

The graft polymers of U.S. Pat. No. 4,301,017 are produced by polymerizing vinyl monomers in the presence of derivatized, water-insoluble starch. In EP1082370B1, starch was dissolved at 82° C., and then monomers were polymerized by emulsion polymerization processes in the presence of this starch solution. WO15160794A1 describes biobased nanoparticles of starch and vinyl monomers. In WO11008272A1, hydrophobically modified starch was produced by reacting water-soluble polysaccharides with hydrophilic monomers and hydrophobic monomers, followed by polymerization with a further monomer mixture. WO2015155159 teaches an aqueous emulsion polymerization of 70 to 95 wt % of vinyl acetate and 5 to 25 wt % of (meth)acrylic esters and also defined amounts of certain further monomers in the presence of starch.

Starch has also variously been recommended as a protective colloid for polymers, such as in U.S. Pat. No. 3,632,535, for example. U.S. Pat. No. 3,769,248 describes vinyl acetate polymer dispersions stabilized with up to 4 wt % of starch as protective colloid. U.S. Pat. No. 4,532,295 teaches emulsion polymerizations of ethylenically unsaturated monomers in the presence of 1 to 5 wt %, based on the monomers, of cyanoalkyl-, hydroxyalkyl- or carboxyalkyl-starch as protective colloid. For U.S. Pat. No. 4,532,295 it is essential to omit emulsifiers during the polymerization. Protective colloids are known to have the function of stabilizing polymers. For example, aqueous dispersions of water-insoluble polymers can be stabilized by protective colloids. With protective colloids it is also possible for water-insoluble polymers to be converted into water-redispersable powders. In these cases the water-insoluble polymers and the protective colloid starch take the form of separate polymers. Compositions in which starch and other polymers are present alongside one another are also referred to as physical mixtures.

Against this background, the object was to provide starch-based binders providing access to fabrics having high tensile bond strengths and to coatings, especially paints, having high wet abrasion resistances.

The object has surprisingly been achieved with starch hybrid copolymers which are based on cold-water-soluble starch and defined amounts of certain ethylenically unsaturated monomers.

A subject of the invention are starch hybrid copolymers in the form of aqueous dispersions or water-redispersable powders, obtainable by radically initiated polymerization in aqueous medium of ethylenically unsaturated monomers in the presence of starch, and optional subsequent drying, characterized in that
the starch hybrid copolymers are based ≥20 wt %, based on the dry weight of the starch hybrid copolymers, on cold-water-soluble starch and
the ethylenically unsaturated monomers comprise either
a) one or more vinyl esters, 1 to 40 wt % of ethylene, 0.1 to 10 wt % of one or more functional monomers, and optionally one or more further ethylenically unsaturated monomers, or
b) styrene, ≥30 wt % of one or more (meth)acrylic esters, 0.1 to 10 wt % of one or more functional monomers, and optionally one or more further ethylenically unsaturated monomers,
where the functional monomers are ethylenically unsaturated and carry one or more epoxy, silane and/or N-methylol groups,
where the weight percent figures for the monomers are based on the total weight of the monomers.

Examples of ethylenically unsaturated monomers carrying epoxy groups are glycidyl acrylate and glycidyl methacrylate.

Examples of ethylenically unsaturated monomers carrying N-methylol groups are N-alkylol-functional comonomers with a C₁ to C₄ alkylol radical, more particularly N-methylol radical, such as N-methylolacrylamide (NMA), N-methylolmethacrylamide, N-methylolallyl carbamate, C₁ to C₄ alkyl ethers of N-methylolacrylamide, N-methylolmethacrylamide and N-methylolallyl carbamate, such as their isobutoxy ethers, for example, and also C₁ to C₄ alkyl esters of N-methylolacrylamide, of N-methylolmethacrylamide and of N-methylolallyl carbamate. Particularly preferred are N-methylolacrylamide, N-methylolmethacrylamide, N-methylolallyl carbamate and C₁ to C₄ alkyl ethers of N-methylolacrylamide such as the isobutoxy ether.

Ethylenically unsaturated monomers carrying silane groups encompass, for example, (meth)acryloyloxypropyltri(alkoxy)silanes or (meth)acryloyloxypropyldialkoxymethylsilanes, vinyltrialkoxysilanes or vinylmethyldialkoxysilanes, where alkoxy groups included may be, for example, methoxy, ethoxy, propoxy, butoxy, acetoxy and ethoxypropylene glycol ether radicals. Preferred ethylenically unsaturated silanes are vinyltrimethoxysilane, vinylmethyldimethoxysilane, vinyltriethoxysilane, vinylmethyldiethoxysilane, vinyltripropoxysilane, vinyltriisopropoxysilane, vinyltris(1-methoxy)isopropoxysilane, vinyltributoxysilane, vinyltriacetoxysilane, 3-methacryloyloxypropyltrimethoxysilane, 3-methacryloyloxypropylmethyldimethoxysilane, methacryloyloxymethyltrimethoxysilane, 3-methacryloyloxypropyltris(2-methoxyethoxy)silane, vinyltrichlorosilane, vinylmethyldichlorosilane, vinyltris(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexyloxysilane, vinyltrioctyloxysilane, vinyldimethoxyoctyloxysilane, vinylmethoxydioctyloxysilane, vinylmethoxydilauryloxysilane, vinyldimethoxylauryloxysilane, and polyethylene glycol-modified silanes. Particularly preferred ethylenically unsaturated silanes are vinyltrimethoxysilane, vinylmethyldimethoxysilane, vinyltriethoxysilane, vinylmethyldiethoxysilane, vinyltris(1-methoxy)isopropoxysilane, methacryloyloxypropyltris(2-methoxyethoxy)silane, 3-methacryloyloxypropyltrimethoxysilane, 3-methacryloyloxypropylmethyldimethoxysilane and methacryloyloxymethyltrimethoxysilane.

Also preferred are starch hybrid copolymers which comprise units of ethylenically unsaturated monomers carrying epoxy groups and also ethylenically unsaturated monomers carrying silane groups.

The fraction of the functional monomers is 0.1 to 10 wt %, preferably 0.2 to 9 wt % and most preferably 0.5 to 7 wt %, based on the total weight of the ethylenically unsaturated monomers.

The fraction of the ethylenically unsaturated monomers carrying N-methylol groups is preferably 0.1 to 10 wt %, more preferably 1 to 9 wt % and most preferably 3 to 7 wt %, based on the total weight of the ethylenically unsaturated monomers.

The fraction of the ethylenically unsaturated monomers carrying epoxy groups is preferably 0.1 to 5 wt %, more preferably 0.2 to 2 wt % and most preferably 0.3 to 1 wt %, based on the total weight of the ethylenically unsaturated monomers.

The fraction of the ethylenically unsaturated monomers carrying silane groups is preferably 0.05 to 3 wt %, more preferably 0.1 to 1 wt % and most preferably 0.2 to 0.5 wt %, based on the total weight of the ethylenically unsaturated monomers.

The total amount of ethylenically unsaturated monomers carrying epoxy groups and ethylenically unsaturated monomers carrying silane groups is preferably 0.15 to 8 wt %, more preferably 0.3 to 3 wt % and most preferably 0.5 to 1.5 wt %, based on the total weight of the ethylenically unsaturated monomers.

In the embodiment a) of the present invention, the ethylenically unsaturated monomers comprise one or more vinyl esters, 1 to 40 wt % of ethylene, 0.1 to 10 wt % of one or more functional monomers, and optionally one or more further ethylenically unsaturated monomers. The further ethylenically unsaturated monomers in this case are generally different from vinyl esters, ethylene and functional monomers. Such starch hybrid copolymers a) are also referred to below as starch-vinyl ester-ethylene hybrid copolymers a).

In the alternative embodiment b) of the present invention, the ethylenically unsaturated monomers comprise styrene, ≥30 wt % of one or more (meth)acrylic esters, 0.1 to 10 wt % of one or more functional monomers, and optionally one or more further ethylenically unsaturated monomers. The further ethylenically unsaturated monomers in this case are generally different from styrene, (meth)acrylic esters and the functional monomers. Such starch hybrid copolymers b) are also referred to below as starch-styrene-(meth)acrylic ester hybrid copolymers b).

Examples of vinyl esters are vinyl esters of unbranched or branched alkylcarboxylic acids having 1 to 18 carbon atoms, such as vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 5 to 15 carbon atoms, for example VeoVa9^{R} or VeoVa10^{R} (tradenames of Shell). Vinyl acetate is preferred.

Preferred starch-vinyl ester-ethylene hybrid copolymers a) are based preferably 50 to 98 wt %, more preferably 60 to 95 wt % and most preferably 75 to 90 wt % on vinyl esters, based on the total weight of the monomers.

Preferred starch-vinyl ester-ethylene hybrid copolymers a) are based preferably 2 to 30 wt %, more preferably 5 to 20 wt % and most preferably 9 to 17 wt % on ethylene, based on the total weight of the monomers.

Examples of (meth)acrylic esters are acrylic esters or methacrylic esters of branched or unbranched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate, 2-ethylhexyl acrylate and norbornyl acrylate. Particularly preferred are methyl acrylate, methyl methacrylate, n-butyl acrylate, 2-ethylhexyl acrylate and norbornyl acrylate.

Preferred starch-styrene-(meth)acrylic ester hybrid copolymers b) are based ≥30 wt %, preferably 31 to 80 wt %, more preferably 35 to 64 wt % and most preferably 40 to 55 wt % on (meth)acrylic esters, based on the total weight of the monomers.

Preferred starch-styrene-(meth)acrylic ester hybrid copolymers b) are based preferably 31 to 69 wt %, more preferably 35 to 64 wt % and most preferably 40 to 55 wt % on styrene, based on the total weight of the monomers.

The starch-vinyl ester-ethylene hybrid copolymers a) are optionally based additionally on one or more further ethylenically unsaturated monomers selected from the group encompassing acrylic esters or methacrylic esters of branched or unbranched alcohols having 1 to 15 carbon atoms, dienes, propene, vinylaromatics and vinyl halides. Preferred are n-butyl acrylate, n-butyl methacrylate, tert-butyl acrylate, tert-butyl methacrylate and vinyl chloride. Such further ethylenically unsaturated monomers form the basis for the starch-vinyl ester-ethylene hybrid copolymers a) to an extent of preferably 0 to 20 wt %, more preferably 0.1 to 15 wt % and most preferably 5 to 10 wt %, based on the total weight of the monomers.

The starch-styrene-(meth)acrylic ester hybrid copolymers b) are optionally based additionally on one or more further ethylenically unsaturated monomers selected from the group encompassing vinyl esters, dienes, olefins, vinyltoluene and vinyl halides. Preferred in this case are olefins. Such further ethylenically unsaturated monomers form the basis of the starch-styrene-(meth)acrylic ester hybrid copolymers b) to an extent of preferably 0 to 20 wt %, more preferably 0.1 to 15 wt % and most preferably 4 to 10 wt %, based on the total weight of the monomers.

Examples of suitable dienes are 1,3-butadiene and isoprene. Examples of olefins are ethene or propene. Vinylaromatics copolymerized may be styrene or vinyltoluene, for example. As vinyl halides, preference is given to vinyl chloride.

The starch hybrid copolymers may optionally be based additionally on one or more auxiliary monomers. Preferably 0 to 20 wt %, more preferably 0.5 to 10 wt %, of auxiliary monomers are copolymerized, based on the total weight of the monomers. Examples of auxiliary monomers are ethylenically unsaturated monocarboxylic and dicarboxylic acids, preferably acrylic acid, methacrylic acid, crotonic acid, fumaric acid and maleic acid; ethylenically unsaturated anhydrides, preferably maleic anhydride; acrylamide; ethylenically unsaturated carbonitriles, preferably acrylonitrile; monoesters and diesters of fumaric acid and maleic acid such as the diethyl and diisopropyl esters; ethylenically unsaturated sulfonic acids and their salts, preferably vinylsulfonic acid and 2-acrylamido-2-methylpropanesulfonic acid. Other examples are precrosslinking comonomers such as polyethylenically unsaturated comonomers, for example diallyl phthalate, divinyl adipate, diallyl maleate, allyl methacrylate or triallyl cyanurate, or postcrosslinking comonomers, for example acrylamidoglycolic acid (AGA), methylacrylamidoglycolic acid methyl ester (MAGME). Mention may also be made of monomers having hydroxyl or CO groups, for example hydroxyalkyl acrylates and methacrylates such as hydroxyethyl, hydroxypropyl or hydroxybutyl acrylate or methacrylate, and also compounds such as diacetoneacrylamide and acetylacetoxyethyl acrylate or methacrylate.

Preferred auxiliary monomers are ethylenically unsaturated monocarboxylic and dicarboxylic acids or their anhydrides and ethylenically unsaturated sulfonic acids or their salts.

The starch hybrid copolymers are based preferably 20 to 80 wt %, more preferably 30 to 75 wt % and most preferably 50 to 70 wt % on ethylenically unsaturated monomers, each based on the dry weight of the starch hybrid copolymers.

The fraction of the ethylenically unsaturated monomers in the starch hybrid copolymers may be ascertained for example by means of NMR spectroscopy, preferably using calibration substances.

The starch-vinyl ester-ethylene hybrid copolymers a) preferably do not contain any (meth)acrylic ester unit.

The starch-styrene-(meth)acrylic ester hybrid copolymers b) contain preferably ≤30 wt % of vinyl ester units, based on the total weight of the monomers, and more preferably contain no vinyl ester unit.

The monomer selection and the selection of the weight fractions of the comonomers are made here such that the starch hybrid copolymers have a glass transition temperature Tg of −50° C. to +120° C., preferably −35° C. to +45° C. The starch units generally do not exhibit a glass transition temperature. The glass transition temperature Tg of the polymers may be ascertained in a known way by Differential Scanning Calorimetry (DSC). The Tg may also be precalculated approximately using the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (wt %/100) of the monomer n, and Tgn is the glass transition temperature in kelvins of the homopolymer of the monomer n. Tg values for homopolymers are listed in Polymer Handbook, 2^{nd} edition, J. Wiley & Sons, New York (1975).

The cold-water-soluble starch has a solubility at 23° C. of preferably ≥10 g per litre of water, more preferably ≥100 g per litre of water and most preferably ≥500 g per litre of water.

Typical sources of the cold-water-soluble starch are, for example, tubers or roots, such as potatoes, maranta (arrowroot), manioc (tapioca) or sweet potato (batata); cereal seeds, such as wheat, maize, rye, rice, barley, millet, oats, triticale or sorghum; fruits, such as bananas, chestnuts, acorns, peas, beans or other legumes, or pith, such as sago. The starch preferably comes from tubers or roots, such as more particularly potatoes or manioc (tapioca), or cereals, such as more particularly wheat or maize. The starch may also be obtained from wastes, for example potato remnants or potato peelings.

The cold-water-soluble starch may for example be native, degraded or chemically modified. Native starch generally contains amylose and/or amylopectin as principal constituent. Native starch is generally not degraded and not chemically modified. Degraded starch generally has a lower average molecular weight than native starch. Starch degradation may take place, for example, enzymatically, oxidatively or by exposure to an acid or a base, more particularly by hydrolysis. This also leads generally to increased levels of oligosaccharides or dextrins. Through chemical modifications, chemical groups are attached via covalent addition to the starch, generally. For chemical modification, native or degraded starches may be used, for example. Chemical modifications are therefore generally different from degradation. Examples of chemical modifications are esterifications or etherifications, such as carboxymethylation, oxidation reactions, or nonionic, anionic or cationic modifications. Examples of chemically modified starches are carboxymethyl-, methyl-, hydroxyethyl- or hydroxypropyl-starch, starch ethers or starch phosphate esters or their oxidation products. The cold-water-soluble starch preferably contains no chemical modifications, more particularly no cyano, hydroxyl, carbonyl, aldehyde, ester and/or carboxyl groups. Preference is given to native cold-water-soluble starch or, in particular, degraded cold-water-soluble starch.

The cold-water-soluble starch has molecular weights of preferably 500 to 1 000 000 g/mol, more preferably 1000 to 500 000 g/mol and most preferably 5000 to 200 000 g/mol.

Aqueous solutions of the cold-water-soluble starch have Brookfield viscosities of preferably 10 to 5000 mPas, more preferably 50 to 3000 mPas (determined with a Brookfield viscometer at 23° C. and 20 rpm with a solids content of the solutions of 50%).

The starch, more particularly the cold-water-soluble starch, has weight-average particle diameters Dw of between preferably 100 and 5000 nm, more preferably 200 to 3000 nm and most preferably 300 and 1000 nm. Dw is determined as described later on below for the starch hybrid copolymers.

The starch hybrid copolymers are based preferably 20 to 80 wt %, more preferably 25 to 70 wt % and most preferably 30 to 50 wt % on cold-water-soluble starch, each based on the dry weight of the starch hybrid copolymers. The starch content of the starch hybrid copolymers may be ascertained conventionally by NMR spectroscopy.

The fraction of the cold-water-soluble starch is preferably ≥50 wt % and more preferably ≥90 wt %, each based on the total weight of the starch included overall. Most preferably the starch present is exclusively cold-water-soluble starch.

The cold-water-soluble starch in the starch hybrid copolymers is preferably in amorphous form. Non-cold-water-soluble native starch, conversely, is generally present in crystalline form (method of determination: x-ray diffractometry).

The cold-water-soluble starch may be produced using the processes commonplace for that purpose. Cold-water-soluble starch is also available commercially, for example under the tradenames ARIC 50.070 from Agrana, Agenamalt 20.225 or Agenamalt 20.226 from Agrana.

The starch hybrid copolymers may optionally be protective colloid-stabilized or preferably emulsifier-stabilized. In one preferred embodiment the starch hybrid copolymers are not protective colloid-stabilized.

Examples of protective colloids are polyvinyl alcohols, polyvinyl acetals, polyvinylpyrrolidones, copolymers of (meth)acrylates with carboxyl-functional comonomer units, poly(meth)acrylamide, polyvinylsulfonic acids and their copolymers, melamine-formaldehyde sulfonates, naphthalene-formaldehyde sulfonates, styrene-maleic acid copolymers and vinyl ether-maleic acid copolymers. Preferred protective colloids are partially hydrolyzed polyvinyl alcohols preferably with a degree of hydrolysis of 80 to 95 mol %, more particularly 85 to 92 mol %, and preferably with a Höppler viscosity, in 4% strength aqueous solution, of 1 to 30 mPas, more particularly 3 to 15 mPas (Höppler method at 20° C., DIN 53015). The stated protective colloids are accessible by methods known to the skilled person.

The protective colloid fraction is preferably 0 to 30 wt %, more preferably 0.1 to 25 wt % and most preferably 0.5 to 20 wt %, based on the total weight of the starch hybrid copolymers.

The starch hybrid copolymers are generally not stabilized with starch. The starch included in the starch hybrid copolymers generally does not act as a protective colloid. In starch-stabilized polymers, the starch and the polymers are generally present merely in the form of conglomerates and/or blends. In starch-stabilized polymers the starch is substantially not attached to the polymers. The starch hybrid copolymers are therefore generally not starch-stabilized polymers.

Anionic, cationic or nonionic emulsifiers may be included. Anionic emulsifiers are preferred, nonionic emulsifiers particularly preferred.

Examples of anionic emulsifiers are alkyl sulfates, alkyl sulfonates or alkyl carboxylates having a chain length of 8 to 18 carbon atoms, alkyl or alkylaryl ether sulfates, sulfonates or carboxylates having 8 to 18 carbon atoms in the hydrophobic radical and up to 40 ethylene or propylene oxide units, alkyl- or alkylarylsulfonates having 8 to 18 carbon atoms, full esters and monoesters of sulfosuccinic acid with monohydric alcohols or alkylphenols, or phosphates, ether phosphates, phosphonates and ether phosphonates, and also combinations thereof.

Examples of nonionic emulsifiers are alkyl polyglycol ethers or alkylaryl polyglycol ethers having 8 to 40 ethylene oxide units or ethylene oxide/propylene oxide block copolymers having 2 to 40 EO and/or PO units or generally EO-PO copolymers, and also alkylpolyglycosides having 1 to 20 carbon atoms and also ether alkylpolyglycosides having 2 to 40 EO and/or PO units, or combinations thereof.

The emulsifier fraction is preferably 0 to 15 wt %, more preferably 0.1 to 5 wt % and most preferably 0.5 to 3 wt %, based on the total weight of the starch hybrid copolymers.

The starch hybrid copolymers in the form of aqueous dispersions have a solids content of preferably 10 to 70% and more preferably 40 to 60%.

The Brookfield viscosity of the aqueous dispersions of the starch hybrid copolymers is preferably 50 to 3000 mPas, more preferably 100 to 1000 mPas (determined with a Brookfield viscometer at 23° C. and 20 rpm with a solids content of the dispersions of 50%). Aqueous dispersions of the starch hybrid copolymers preferably have lower viscosities than mere blends of corresponding amounts of starch and corresponding copolymers.

The starch hybrid copolymers have weight-average particle diameters Dw of between preferably 100 and 10 000 nm, more preferably 200 and 8000 nm and most preferably 300 to 6000 nm.

The parameters Dw and Dn and the particle size distribution are determined by means of laser light diffraction and laser light scattering on the basis of the starch hybrid copolymers using the LS13320 instrument with the PVAC.RF780D optical model, including PIDS, from Beckmann-Coulter, observing the protocol of the instrument manufacturer, after adequate dilution of the aqueous polymer dispersions with fully demineralized water.

In the starch hybrid copolymers, the cold-water-soluble starch is attached preferably via covalent bonds to the polymer units of the ethylenically unsaturated monomers. The attachment may be made, for example, by grafting as part of the radically initiated polymerization, or by condensation or addition reactions of the functional groups of the functional monomer units.

The starch hybrid copolymers preferably do not have a core-shell structure. The monomers are preferably copolymerized statistically. Starch is incorporated preferably statistically into the starch hybrid copolymers.

A further subject of the invention are processes for producing starch hybrid copolymers in the form of aqueous dispersions or water-redispersable powders by means of radically initiated polymerization, more particularly emulsion polymerization, in aqueous medium of ethylenically unsaturated monomers in the presence of starch and optional subsequent drying, characterized in that
≥20 wt %, based on the total dry weight of the starch and the ethylenically unsaturated monomers, of cold-water-soluble starch is introduced and
as ethylenically unsaturated monomers either
a) one or more vinyl esters, 1 to 40 wt % of ethylene, 0.1 to 10 wt % of one or more functional monomers, and optionally one or more further ethylenically unsaturated monomers, or
b) styrene, ≥30 wt % of one or more (meth)acrylic esters, 0.1 to 10 wt % of one or more functional monomers, and optionally one or more further ethylenically unsaturated monomers are used,
where the functional monomers are ethylenically unsaturated and carry one or more epoxy, silane and/or N-methylol groups,
where the weight percent figures for the monomers are based on the total weight of the monomers.

The temperature for the polymerization is preferably 40° C. to 120° C., more preferably 60° C. to 95° C. In the case of copolymerization of gaseous comonomers such as ethylene, 1,3-butadiene or vinyl chloride, it is also possible to operate under superatmospheric pressure, generally between 5 bar and 100 bar.

Suitable radical initiators are commonplace oil-soluble or water-soluble initiators. Examples of oil-soluble initiators are oil-soluble peroxides, such as tert-butyl peroxy-2-ethylhexanoate, tert-butyl peroxypivalate, tert-butyl peroxyneodecanoate, dibenzoyl peroxide, tert-amyl peroxypivalate, di(2-ethylhexyl) peroxydicarbonate, 1,1-bis(tert-butylperoxy)-3,3,5-trimethylcyclohexane, di(4-tert-butylcyclohexyl) peroxydicarbonate, dilauroyl peroxide, cumyl hydroperoxide, or oil-soluble azo initiators, such as azobisisobutyronitrile or dimethyl 2,2′-azobis(2-methylpropionate). Examples of water-soluble initiators are peroxodisulfates, such as potassium peroxodisulfate, hydrogen peroxide, water-soluble hydroperoxides such as tert-butyl hydroperoxide, manganese(III) salts or cerium(IV) salts. The initiators are used generally in an amount of 0.005 to 3.0 wt %, preferably 0.01 to 1.5 wt %, based in each case on the total weight of the ethylenically unsaturated monomers. The use of redox initiators is preferred. Redox initiators used are combinations of the stated initiators in combination with reducing agents. Examples of suitable reducing agents are sodium sulfite, iron(II) salts, sodium hydroxymethanesulfinate and ascorbic acid. Preferred redox initiators are cerium(IV) salts, such as ammonium cerium(IV) nitrate, manganese(III) salts or peroxodisulfates, and combinations of these initiators. Where reducing agents are used, the amount of reducing agent is preferably 0.01 to 0.5 wt %, based on the total weight of the ethylenically unsaturated monomers.

The reaction mixture may be stabilized, for example, by protective colloids and/or preferably emulsifiers.

The polymerization may be carried out with all or individual constituents of the reaction mixture included in the initial charge, or with some included in the initial charge and all or individual constituents of the reaction mixture metered in subsequently, or by the metering method without an initial charge. The procedure is preferably such that at least a part, preferably the entire amount, of starch is included in the initial charge, in particular in water. The ethylenically unsaturated monomers and the initiators are included entirely or preferably partly in the initial charge, and the remaining amount, where appropriate, of ethylenically unsaturated monomers and initiators is metered in. The functional monomers may be included, for example, entirely or partly in the initial charge. With preference the functional monomers are metered in in their entirety. Where a batch process is carried out, the monomers and the starch and also a part of the initiator are included in the initial charge in water, and the initiator remainder is metered in or added in pulses.

After the end of the polymerization, residual monomers may be removed by post-polymerization using known methods. Volatile residual monomers and other volatile constituents may also be removed by distillation or stripping methods, preferably under reduced pressure.

Aqueous dispersions of the starch hybrid copolymers may be converted by drying into starch hybrid copolymers in the form of water-redispersable powders. For this purpose the aqueous dispersions are generally admixed with drying assistants, preferably 0.5 to 30 wt %, more particularly 5 to 20 wt %, based on the solids content of the aqueous dispersion. The total amount of drying assistant and protective colloid before the drying operation is preferably 1 to 30 wt %, based on the solids content of the aqueous dispersion.

The aqueous dispersions may be dried for example by fluidized bed drying, freeze drying or, preferably, spray drying. The spray drying may be carried out in customary spray drying units, where atomization may take place using single, double or multiple fluid nozzles or with a rotating disk. The exit temperature chosen is generally in the range from 45° C. to 120° C., preferably 60° C. to 90° C., according to unit, Tg of the starch hybrid copolymer and desired drying level. The viscosity of the feed for atomization is adjusted via the solids content to a value of <500 mPas (Brookfield viscosity at 20 revolutions and 23° C.), preferably ≤250 mPas. The solids content of the dispersion for atomization is preferably 30 to 75 wt % and more preferably 50 to 60 wt %.

In many cases an amount of up to 1.5 wt % of antifoam agent, based on the starch hybrid copolymer, has proven useful. Antifoam agent is added preferably during the atomization.

In order to extend the shelf life by improving the blocking stability, particularly in the case of starch hybrid copolymer powders with low glass transition temperature, the resulting powder may be equipped, for example, with one or more antiblocking agents (anticaking agents). The antiblocking agents are preferably added not to the aqueous starch hybrid copolymer dispersions, i.e. preferably not before drying, but instead preferably during or after the drying, more particularly during the drying, into the spray drying unit. Preferred powders contain antiblocking agent, more particularly 1 to 30 wt %, based on the total weight of polymeric constituents. Examples of antiblocking agents are Ca and/or Mg carbonate, talc, gypsum, silica, kaolins such as metakaolin, silicates, preferably with particle sizes in the range from 10 nm to 10 μm.

The starch hybrid copolymers are suitable generally as binders for coating compositions or adhesive bonding compositions, in particular for paints, fibres, textiles, leather, paper or carpets. A particularly preferred use of the starch hybrid copolymers is as binders for the binding of fibre materials, more particularly for the production of fabrics, such as nonwovens, woven and knitted goods, leather and furs, or carpets, or as binders for construction coatings, more particularly aqueous emulsion paints or powder paints.

The starch hybrid copolymers are also suitable, furthermore, for use in chemical products in the construction industry. They may be used alone or in combination with conventional polymer dispersions or dispersion powders, optionally in conjunction with hydraulically setting binders such as cements (Portland, aluminate, trass, blast furnace, magnesia or phosphate cement), gypsum and waterglass for the production of levelling compositions, construction adhesives, renders, filling compounds, jointing mortars, grouts, external wall integrated coating systems or paints, such as powder paints. Among construction adhesives, tile adhesives or adhesives for exterior wall insulation systems are preferred fields of use. Preferred fields of application are also levelling compositions; preferred levelling compositions are self-levelling floor filling compounds and screeds.

In applications, the starch hybrid copolymers of the invention lead surprisingly to advantageous mechanical properties, not least after water storage. Accordingly, fabrics bound using starch hybrid copolymers have, for example, high tensile bond strengths, more particularly high wet tensile strengths. Corresponding paint applications are distinguished by high abrasion resistances, and especially by high wet abrasion resistances.

The starch hybrid copolymers of the invention in the form of aqueous dispersions, water-redispersable powders or corresponding aqueous redispersions advantageously are stable in storage, do not show a tendency towards separation, and enable access to homogeneous compositions.

As well as the objective of increased introduction of renewable raw materials into polymer applications, another effect of the starch hybrid copolymers of the invention is to attain improved biodegradability of the application products, this being another important environmental criterion.

The examples below serve for further elucidation of the invention.

### ADDITIVES USED IN THE EXAMPLES

| | |
|---|---|
| Aerosol A102: | ethoxylated succinic monoester, disodium salt; |
| Melon 20: | sodium alkylbenzenesulfonate; |
| NMA-LF: | N-methylolacrylamide with low formaldehyde content (48% in |
| | water); |
| Silfoam SE2: | silicone-based antifoam emulsion; |
| Genapol PF 40: | block copolymer of propylene oxide and ethylene oxide with 40% |
| | ethylene oxide; |
| Genapol X150: | isotridecyl alcohol ethoxylate with 15 mol of ethylene oxide; |
| Mersolat: | mixture of secondary sodium alkylsulfonates with a mean chain |
| | length of 15 carbon atoms; |
| PVOH 25/140: | polyvinyl alcohol, degree of hydrolysis 88%, Hoppler viscosity 25 |
| | mPas; |
| Geniosil GF 56: | triethoxyvinylsilane; |
| GMA: | glycidyl methacrylate; |
| Foamaster 2315: | mineral oil-based defoamer; |
| Acticide MBS: | mixture of methylisothiazolinone and benzisothiazolinone; |
| TBHP: | tert-butyl hydroperoxide; |
| Brüggolit FF6: | 2-hydroxy-2-sulfinoacetic acid, disodium salt; |
| ARIC 50.070: | enzymatically modified potato starch (M_{w} ~146 000 g/mol) from |
| | Agrana, in powder form; |
| Agenamalt 20.225: | maltodextrin from potato starch (M_{w} ~9730 g/mol) from Agrana, in |
| | powder form; |
| Agenamalt 20.226: | maltodextrin from potato starch (M_{w} ~95 000 g/mol) from Agrana, |
| | in powder form; |
| Dynaplak 2020: | non-cold-water-soluble potato starch (Mw ~14 000 g/mol) from |
| | Dynaplak, 35% suspension. |

### Example 1

NMA-Containing Starch Hybrid Copolymer with 20.2% Starch:

With stirring, a laboratory autoclave (5 L) was charged with the following:
1545 g of deionized water,
4.36 g of citric acid,
0.764 g of sodium citrate,
75.9 g of Aerosol A102 (30%),
80.8 g of Melon 20 (20%),
16.4 g of sodium vinylsulfonate (25%) and
493 g of ARIC 50.070.

The pH was adjusted to 4.0 and 1.20 g of iron(II) ammonium sulfate were added. The autoclave was then evacuated and charged with nitrogen. 1397 g of vinyl acetate were added, the reactor was heated to 40° C., and 300 g of ethylene were injected. Then aqueous tert-butyl hydroperoxide solution (3%) was started at a rate of 45.3 g/h and aqueous sodium isoascorbate solution (5.7%) at a rate of 45.0 g/h. After the start of reaction, apparent from an increase in the internal temperature, the initiator rates were reduced (TBHP 16.6 g/h, sodium isoascorbate 16.4 g/h), and 195 g of NMA-LF, in solution in 132 g of deionized water, were metered in at a rate of 109 g/h over the course of 180 min. From the start of reaction, the internal temperature was raised from 55° C. to 60° C. at a rate of 0.25° C./min. 60 min after the start of reaction, the metering of 246 g of vinyl acetate was commenced, at a rate of 123 g/h. After the end of the monomer feeds, the initiator feeds continued for 60 min more. The batch was subsequently cooled to 30° C. and let down. 0.854 g of Silfoam SE2 was added, followed by post-polymerization using 11.5 g of TBHP (10%) and 22.6 g of sodium isoascorbate (6.25%). The batch was adjusted to a pH of 6.0 with ammonia (12.5%) and preserved using hydrogen peroxide (10%).

### Example 2

NMA-Containing Starch Hybrid Copolymer with 29.7% Starch:

With stirring, a laboratory autoclave (5 L) was charged with the following:
1597 g of deionized water,
3.84 g of citric acid,
0.672 g of sodium citrate,
66.6 g of Aerosol A102 (30%),
71.1 g of Melon 20 (20%),
14.4 g of sodium vinylsulfonate (25%) and
723 g of ARIC 50.070.

The pH was adjusted to 4.0 and 1.06 g of iron(II) ammonium sulfate were added. The autoclave was then evacuated and charged with nitrogen. 1230 g of vinyl acetate were added, the reactor was heated to 40° C., and 265 g of ethylene were injected. Then aqueous tert-butyl hydroperoxide solution (3%) was started at a rate of 40.0 g/h and aqueous sodium isoascorbate solution (5.7%) at a rate of 39.7 g/h. After the start of reaction, apparent from an increase in the internal temperature, the initiator rates were reduced (TBHP 14.6 g/h, sodium isoascorbate 14.5 g/h), and 172 g of NMA-LF, in solution in 116 g of deionized water, were metered in at a rate of 96.0 g/h over the course of 180 min. From the start of reaction, the internal temperature was raised from 55° C. to 60° C. at a rate of 0.25° C./min. 60 min after the start of reaction, the metering of 217 g of vinyl acetate was commenced, at a rate of 108.5 g/h. After the end of the monomer feeds, the initiator feeds continued for 60 min more. The batch was subsequently cooled to 30° C. and let down. 0.752 g of Silfoam SE2 was added, followed by post-polymerization using 10.1 g of TBHP (10%) and 19.9 g of sodium isoascorbate (6.25%). The batch was adjusted to a pH of 6.0 with ammonia (12.5%) and preserved using hydrogen peroxide (10%).

### Example 3

NMA-Containing Starch Hybrid Copolymer with 45.6% Starch:

With stirring, a laboratory autoclave (5 L) was charged with the following:
1686 g of deionized water,
2.96 g of citric acid,
0.518 g of sodium citrate,
51.5 g of Aerosol A102 (30%),
54.8 g of Melon 20 (20%),
11.1 g of sodium vinylsulfonate (25%) and
1115 g of ARIC 50.070.

The pH was adjusted to 4.0 and 0.814 g of iron(II) ammonium sulfate was added. The autoclave was then evacuated and charged with nitrogen. 947 g of vinyl acetate were added, the reactor was heated to 40° C., and 204 g of ethylene were injected. Then aqueous tert-butyl hydroperoxide solution (3%) was started at a rate of 30.7 g/h and aqueous sodium isoascorbate solution (5.7%) at a rate of 30.8 g/h. After the start of reaction, apparent from an increase in the internal temperature, the initiator rates were reduced (TBHP 11.2 g/h, sodium isoascorbate 11.1 g/h), and 132 g of NMA-LF, in solution in 89.5 g of deionized water, were metered in at a rate of 70.7 g/h over the course of 180 min. From the start of reaction, the internal temperature was raised from 55° C. to 60° C. at a rate of 0.25° C./min. 60 min after the start of reaction, the metering of 167 g of vinyl acetate was commenced, at a rate of 83.5 g/h. After the end of the monomer feeds, the initiator feeds continued for 60 min more. The batch was subsequently cooled to 30° C. and let down. 0.580 g of Silfoam SE2 was added, followed by post-polymerization using 7.8 g of TBHP (10%) and 15.3 g of sodium isoascorbate (6.25%). The batch was adjusted to a pH of 6.0 with ammonia (12.5%) and preserved using hydrogen peroxide (10%).

### Example 4

GMA- and Silane-Containing Starch Hybrid Copolymer with 30.5% Starch:

With stirring, the following were charged to a laboratory autoclave (5 L):
863 g of ARIC 50.070,
43.2 g of Genapol PF 40 (20%),
75.5 g of Genapol X150 (40%),
31.7 g of Mersolat (30%),
13.8 g of sodium vinylsulfonate (25%) and
86.3 g of PVOH 25/140 (10%).

The aqueous charge was adjusted to a pH of 4.0 and 5.18 g of iron(II) ammonium sulfate (1%) were added. The autoclave was then evacuated and charged with nitrogen. 171 g of vinyl acetate were added, the reactor was heated to 70° C., and 81.5 g of ethylene were injected. The initiator feeds were commenced: TBHP (10%) was metered at 2.37 g/h, Brüggolit FF6 (5%) at 8.39 g/h. After the start of reaction, evident from an increase in the internal temperature, the internal temperature was raised to 80° C. The rates of the initiator feeds were then increased (TBHP: 5.13 g/h; FF6: 18.7 g/h) and the following feeds were commenced:
1204 g of vinyl acetate in 135 min,
2.76 g of formic acid (50%), in solution in 173 g of deionized water, in 180 min,
142 g of ethylene, so that the reaction pressure was 35 bar.

From the end of metering of the vinyl acetate, 5.18 g of Geniosil GF 56, in solution in 261 g of vinyl acetate, were metered in over the course of 30 min. Then 9.49 g of GMA, in solution in 79.4 g of vinyl acetate, were metered in over the course of 10 min. 10.4 g of vinyl acetate were added subsequently and the initiators were metered in for a further 40 min at rates of 6.25 g/h (TBHP) and 22.8 g/h (FF6). The batch was cooled and let down and 0.218 g of Foamaster 2315 was added. The dispersion was preserved using Acticide MBS.

### Example 5

GMA- and Silane-Containing Starch Hybrid Copolymer with 30.5% Maltodextrin:

Reaction procedure and quantities as in example 4, but replacing ARIC 50.070 with Agenamalt 20.225.

### Example 6

GMA- and Silane-Containing Starch Hybrid Copolymer with 30.5% Starch:

Reaction procedure and quantities as in example 4, but replacing ARIC 50.070 with Agenamalt 20.226.

### Comparative Example 1

### NMA-Containing Copolymer Dispersion:

With stirring, a laboratory autoclave (5 L) was charged with the following: 901 g of deionized water,
6.45 g of citric acid,
1.13 g of sodium citrate,
112 g of Aerosol A102 (30%),
119 g of Melon 20 (20%) and
24.2 g of sodium vinylsulfonate (25%).

The pH was adjusted to 4.0 and 1.77 g of iron(II) ammonium sulfate were added. The autoclave was then evacuated and charged with nitrogen. 2065 g of vinyl acetate were added, the reactor was heated to 40° C., and 444 g of ethylene were injected. Then aqueous tert-butyl hydroperoxide solution (3%) was started at a rate of 67.3 g/h and aqueous sodium isoascorbate solution (5.7%) at a rate of 67.3 g/h. After the start of reaction, apparent from an increase in the internal temperature, the initiator rates were reduced (TBHP 24.6 g/h, sodium isoascorbate 25.6 g/h), and 288 g of NMA-LF, in solution in 195 g of deionized water, were metered in at a rate of 161 g/h over the course of 180 min. From the start of reaction, the internal temperature was raised from 55° C. to 60° C. at a rate of 0.25° C./min. 60 min after the start of reaction, the metering of 364 g of vinyl acetate was commenced, at a rate of 182 g/h. After the end of the monomer feeds, the initiator feeds continued for 60 min more. The batch was subsequently cooled to 30° C. and let down. 1.26 g of Silfoam SE2 were added, followed by post-polymerization using 17.0 g of TBHP (10%) and 33.4 g of sodium isoascorbate (6.25%). The batch was adjusted to a pH of 6.0 with ammonia (12.5%) and preserved using hydrogen peroxide (10%).

### Comparative Example 2

Blend of an NMA-Containing Copolymer Dispersion with 20.2% ARIC 50.070:

The NMA-containing copolymer dispersion from comparative example 1 was admixed subsequently with 20.2% of ARIC 50.070.

### Comparative Example 3

Blend of an NMA-Containing Copolymer Dispersion with 29.7% ARIC 50.070:

The NMA-containing copolymer dispersion from comparative example 1 was admixed subsequently with 29.7% of ARIC 50.070.

### Comparative Example 4

Blend of an NMA-Containing Copolymer Dispersion with 45.6% ARIC 50.070:

The NMA-containing copolymer dispersion from comparative example 1 was admixed subsequently with 45.6% of ARIC 50.070.

### Comparative Example 5

### GMA- and Vinylsilane-Containing Copolymer Dispersion:

With stirring, the following were charged to a laboratory autoclave (5 L):
63.6 g of Genapol PF 40 (20%),
111 g of Genapol X150 (40%),
46.6 g of Mersolat (30%),
20.4 g of sodium vinylsulfonate (25%) and
246 g of PVOH 25/140 (10%).

The aqueous charge was adjusted to a pH of 4.0 and 7.63 g of iron(II) ammonium sulfate (1%) were added. The autoclave was then evacuated and charged with nitrogen. 252 g of vinyl acetate were added, the reactor was heated to 70° C., and 120 g of ethylene were injected. The initiator feeds were commenced: TBHP (10%) was metered at 3.40 g/h, Brüggolit FF6 (5%) at 12.8 g/h. After the start of reaction, evident from an increase in the internal temperature, the internal temperature was raised to 80° C. The rates of the initiator feeds were then increased (TBHP: 7.40 g/h; FF6: 27.7 g/h) and the following feeds were commenced:
1775 g of vinyl acetate in 135 min,
4.07 g of formic acid (50%), in solution in 254 g of deionized water, in 180 min,
210 g of ethylene, so that the reaction pressure was 35 bar.

From the end of metering of the vinyl acetate, 7.63 g of Geniosil GF 56, in solution in 385 g of vinyl acetate, were metered in over the course of 30 min. Then 14.0 g of GMA, in solution in 117 g of vinyl acetate, were metered in over the course of 10 min. 15.3 g of vinyl acetate were added subsequently and the initiators were metered in for a further 40 min at rates of 9.11 g/h (TBHP) and 33.8 g/h (FF6). The batch was cooled and let down and 0.321 g of Foamaster 2315 was added. The dispersion was preserved using Acticide MBS.

### Comparative Example 6

Copolymer Dispersion with 30.5% Starch, without GMA/Silane:

Reaction procedure and quantities as in example 4, but without using GMA and Geniosil GF 56.

### Comparative Example 7

GMA- and Vinylsilane-Containing Copolymer Dispersion with 30.5% Non-Cold-Water-Soluble Starch:

Reaction procedure and quantities as in example 4, but with ARIC 50.070 replaced with Dynaplak 2020. The dispersion was extremely foamy and contained a very large number of gel specks. It was completely unsuitable for producing a paint.

TABLE 1
Characterization of the dispersions of
the inventive and comparative examples:

| | | | Viscosity | | | |
|---|---|---|---|---|---|---|
| | SC | | BF20 | D_{w} | Dₙ | T_{g} |
| | [%] | pH | [mPas] | [μm] | [μm] | [° C.] |
| Ex. 1 | 53.6 | 4.3 | 1790 | 2.618 | 0.114 | 10.1 |
| Ex. 2 | 53.7 | 4.3 | 1250 | 3.137 | 0.105 | 9.0 |
| Ex. 3 | 52.1 | 4.2 | 1250 | 1.945 | 0.511 | 10.1 |
| Ex. 4 | 58.6 | 4.4 | 1820 | 3.049 | 0.345 | 9.1 |
| Ex. 5 | 58.1 | 4.4 | 2100 | 5.874 | 0.106 | 8.0 |
| Ex. 6 | 58.2 | 4.2 | 3800 | 3.527 | 0.324 | 9.4 |
| CEx. 1 | 62.7 | 5.3 | 21 300 | 1.999 | 0.098 | — |
| CEx. 2 | 49.7 | 5.1 | 1300 | — | — | — |
| CEx. 3 | 48.7 | 5.1 | 1120 | — | — | — |
| CEx. 4 | 47.4 | 5.0 | 1060 | — | — | — |
| CEx. 5 | 59.6 | 4.5 | 7740 | 0.534 | 0.397 | 10.5 |
| CEx. 6 | 58.5 | 4.4 | 1370 | 0.82 | 0.411 | 9.5 |
| CEx. 7 | 57.7 | 4.6 | not measurable | 2.072 | 0.125 | 13.1 |

### Performance Testing in Paint Applications

Interior Paint with a Pigment Volume Concentration (PVC) of 70%

### Paint Formulations:

The paint formulations were based on the ingredients indicated in table 2.

TABLE 2
Paint formulations:

| Ingredient | Amount [g] |
|---|---|
| Water | 360 |
| Dispersing assistant | 4 |
| Defoamer | 3 |
| Titanium dioxide, pigment | 115 |
| Thickener | 5 |
| Calcium carbonate | 211 |
| Talc | 134 |
| Sodium aluminium silicate | 14 |
| Diatomaceous earth | 14 |
| Biocide | 4 |
| NaOH (20%) | 1 |
| Dispersion (50%) | 135 |
| Total amount | 1000 |

The paint formulations were mixed using a dissolver. Water was added at the start. Then dispersing assistant, defoamer, thickener and sodium hydroxide solution were added individually with stirring in each case for 5 minutes at 300 to 400 rpm. The speed was then increased to 800 to 1000 rpm and the pigments, fillers and dispersion from the respective inventive/comparative example were added individually. The amount of dispersion here was adapted to the corresponding solids content. Lastly the formulation was dispersed for at least 30 minutes at 800 to 1000 rpm.

### Viscosities of the Paint Formulations:

The Brookfield viscosities of the paint formulations were determined experimentally one day after their preparation, at 1 rpm, 10 rpm and 100 rpm. The ICI viscosity was determined using a cone/plate viscometer at a shear rate of 10 000 s⁻¹.

Table 3 indicates the results for the paint formulations containing the dispersions of examples 4 to 6 and comparative examples 5 to 6.

TABLE 3
Brookfield viscosities of the paint formulations:

| | Brookfield | Brookfield | Brookfield | |
|---|---|---|---|---|
| | 1 min⁻¹ | 10 min⁻¹ | 100 min⁻¹ | ICI viscosity |
| Dispersion | [mPa s] | [mPa s] | [mPa s] | [mPa s] |
| Ex. 4 | 12 000 | 4900 | 1800 | 205 |
| Ex. 5 | 89 000 | 15 500 | 3600 | 205 |
| Ex. 6 | 35 000 | 9100 | 2800 | 205 |
| CEx. 5 | 97 000 | 13 300 | 3250 | 185 |
| CEx. 6 | 8000 | 4000 | 1600 | 200 |

### Gloss Values of the Paint Formulations:

The gloss values were measured according to DIN EN 13 300. For this the paint formulations were applied in a wet film thickness of 150 μm to a white Leneta sheet and then stored for 24 hours under standard conditions (23±2° C. and 50±5% relative humidity). The gloss value was determined using a three-angle gloss meter.

The results of the testing are compiled in table 4.

TABLE 4
Gloss values of the paint formulations:

| Dispersion | Gloss value at 85° |
|---|---|
| Ex. 4 | 6.2 |
| Ex. 5 | 4.4 |
| Ex. 6 | 4.8 |
| CEx. 5 | 3.5 |
| CEx. 6 | 7.0 |

### Wet Abrasion of the Paint Formulations:

The wet abrasion was measured using a modified test method according to DIN EN 13 300. For this the paint formulations were applied in a wet film thickness of 300 μm to a PVC sheet. Initial drying took place for three days under standard conditions (23±2° C. and 50±5% relative humidity). The samples were then stored in an oven at 50° C. for 24 hours and relaxed for a further 24 hours under standard conditions (23±2° C. and 50±5% relative humidity). The loss of film thickness was ascertained after 200 or 40 wet abrasion cycles using an abrasive nonwoven.

TABLE 5
Wet abrasion of the paint samples:

Wet abrasion [μm]

| Dispersion | after 200 cycles | after 40 cycles |
|---|---|---|
| Ex. 4 | 42.0 | — |
| Ex. 5 | 57.2 | — |
| Ex. 6 | 57.0 | — |
| CEx. 6 | through | 47.0 |

The wet abrasion values for examples 4 to 6 (table 5) make it clear that starch hybrids having particularly good wet abrasion values are obtained with monomers containing silane groups. Conversely, the starch-containing dispersion without silane (CEx. 6) failed completely.

### Performance Testing on Fabrics

### Production of Fabrics:

Fabrics were produced using an aqueous binder composition in an amount of preferably 1 to 50 wt %, more preferably 10 to 30 wt % and most preferably 15 to 25 wt %, based in each case on the total weight of the fibres. The fraction of the fibres was preferably 40 to 99 wt %, more preferably 60 to 90 wt % and most preferably 70 to 80 wt %, based in each case on the total weight of the fabrics. The article was subsequently heat-set at <220° C. for <5 min.

### Compatibility and Storage Stability of the Starch Hybrid Copolymer Dispersions in Comparison to Starch-Copolymer Mixtures:

Dispersions of the starch hybrid copolymers of examples 1 to 3 were compared for their storage stability with dispersions of the blends of comparative examples 2 to 4. For this purpose the dispersions were tested for storage stability or phase separation at the times indicated in table 6.

The results are compiled in table 6.

Surprisingly it was found that the dispersions of the starch hybrid copolymers of the invention were much more storage-stable than the comparative dispersions containing starch and copolymers in the form of physical mixtures.

TABLE 6
Storage stability of the dispersions:

| Dispersion | immediate | 1 day | 1 week | 1 month |
|---|---|---|---|---|
| CEx. 2 | stable | stable | stable | separation |
| Ex. 1 | stable | stable | stable | stable |
| CEx. 3 | stable | stable | separation | — |
| Ex. 2 | stable | stable | stable | stable |
| CEx. 4 | stable | stable | separation | — |
| Ex. 3 | stable | stable | stable | stable |

### Determination of the Biodegradability:

The starch hybrid copolymers of the invention from example 1 and the reference substance from comparative example 1 were each applied to cellulose powder and tested for aerobic biodegradability in accordance with ISO 14855-1 (table 7).

In comparison to the pure polymer binder of comparative example 1, the starch hybrid copolymers of example 1 exhibit a significantly higher biodegradability and obtain a relative degradability rate of about 90%, as evident from table 7.

TABLE 7
biodegradability:

| | Application to cellulose | Relative |
|---|---|---|
| | (solids/solids) | biodegradability |
| Dispersion | [%] | [%] |
| CEx. 1 | 25 | 84.6 |
| Ex. 1 | 25 | 89.7 |

### Determination of the Strength Values of the Nonwoven:

A thermally prebonded nonwoven airlaid web (75 g/m²; 88% fluff pulp and 12% PP/PE bicomponent fibres; 0.85 mm thickness) was sprayed homogeneously on both sides with the dispersion of the respective example or comparative example diluted with water to a solids content of 20%, using the airless process (Unijet 8001 E slot nozzles; 5 bar) to apply a sprayable liquor using a semi-automatic spraying assembly, and then dried in a laboratory through-air dryer (Mathis LTF; Mathis/CH) at 160° C. for 3 min (application rate: 20 wt % of polymer based on the total weight of polymer and nonwoven).

For each breaking strength test, 10 web strips (20 cm clamped length; 5 cm clamped length) were prepared in the cross direction to the machine direction.

The strengths were determined in analogy to DIN EN 29073 (Part 3: Test methods for nonwovens, 1992) and the measurement samples were run by means of an ultimate tensile force measurement on a Zwick® 1445 testing machine (100 N load cell) with TestXpert® software version 11.02 (from Zwick Roell) with a clamped length of 100±1 mm, a clamped width of 15±1 mm and a deformation velocity of 150 mm/min.

The results of the testing are compiled in table 8.

TABLE 8
Strength of nonwovens:

| | Tensile strength | | Elongation Fmax | | |
|---|---|---|---|---|---|
| | [g/5 cm] | | [%] | | Binder application |
| Dispersion | dry | wet | dry | wet | [%] |
| Ex. 1 | 3215 | 839 | 25.8 | 22.5 | 21.4 |
| CEx. 2 | 3078 | 666 | 28.0 | 18.3 | 21.6 |
| Ex. 2 | 3203 | 679 | 26.8 | 19.2 | 21.8 |
| CEx. 3 | 3523 | 473 | 27.7 | 16.5 | 21.8 |

The results show that the starch hybrid copolymers of the invention from examples 1 and 2 lead to better wet tensile strengths than the mixtures of comparative examples 2 and 3.

In spite of the starch content, which typically has a hardening effect, the nonwovens with the starch hybrid copolymers of the invention had a pleasing softness and exhibited the desired elasticity (elongation).

1-11. (canceled)

12. A starch hybrid copolymers in the form of aqueous dispersions or water-redispersible powders, comprising:
wherein the starch hybrid copolymers are obtainable by radically initiated polymerization in aqueous medium of ethylenically unsaturated monomers in the presence of starch, and optional subsequent drying;
wherein the starch hybrid copolymers are based ≥20 wt %, based on the dry weight of the starch hybrid copolymers, on cold-water-soluble starch;
wherein the ethylenically unsaturated monomers comprise 50 to 98 wt % of one or more vinyl esters, 1 to 40 wt % of ethylene, 0.1 to 10 wt % of one or more functional monomers, and optionally one or more further ethylenically unsaturated monomers;
wherein the one or more functional monomers are ethylenically unsaturated and carry one or more epoxy, silane and/or N-methylol groups; and
wherein the wt % figures for the monomers are based on the total weight of the monomers.

13. The starch hybrid copolymers of claim 12, wherein the one or more functional monomers carrying epoxy groups are selected from the group encompassing glycidyl acrylate and glycidyl methacrylate; one or more functional monomers carrying N-methylol groups are selected from the group encompassing N-methylolacrylamide, N-methylolmethacrylamide, N-methylolallyl carbamate, C₁ to C₄ alkyl ethers of N-methylolacrylamide, N-methylolmethacrylamide and N-methylolallyl carbamate, and C₁ to C₄ alkyl esters of N-methylolacrylamide, of N-methylolmethacrylamide and of N-methylolallyl carbamate; and/or
wherein the one or more functional monomers carrying silane groups are selected from the group encompassing (meth)acryloyloxypropyltri(alkoxy)silanes, (meth)acryloyloxypropyldialkoxymethylsilanes, vinyltrialkoxysilanes and vinylmethyldialkoxysilanes, wherein alkoxy groups included are methoxy, ethoxy, propoxy, butoxy, acetoxy and ethoxypropylene glycol ether radicals.

14. The starch hybrid copolymers of claim 12, wherein the ethylenically unsaturated monomers a) comprise 60 to 95 wt % of one or more vinyl esters, 2 to 30 wt % of ethylene, 0.2 to 9 wt % of the one or more functional monomers, and optionally one or more further ethylenically unsaturated monomers, each based on the total weight of the monomers.

15. The starch hybrid copolymers of claim 12, wherein the further ethylenically unsaturated monomers comprise one or more ethylenically unsaturated monocarboxylic or dicarboxylic acids or anhydrides thereof or salts thereof and/or one or more ethylenically unsaturated sulfonic acids or salts thereof.

16. The starch hybrid copolymers of claim 12, wherein the starch hybrid copolymers are based 20 to 80 wt % on ethylenically unsaturated monomers, based on the dry weight of the starch hybrid copolymers.

17. The starch hybrid copolymers of claim 12, wherein the cold-water-soluble starch is soluble at 23° C. to ≥10 g per liter of water.

18. The starch hybrid copolymers of claim 12, wherein the cold-water-soluble starch has Brookfield viscosities of 10 to 5000 mPas (determined with a Brookfield viscometer at 23° C., 20 rpm and a solids content in water of 50%).

19. The starch hybrid copolymers of claim 12, wherein the fraction of the cold-water-soluble starch, based on the total weight of the starch included overall, is ≥50 wt %.

20. The starch hybrid copolymers of claim 12, wherein the starch hybrid copolymers are used as binders for coating compositions or adhesive bonding compositions, more particularly for paints, textiles, paper or carpets.

21. The starch hybrid copolymers of claim 12, wherein the starch hybrid copolymers are used in leveling compositions, construction adhesives, tile adhesives, adhesives for external wall insulation systems, renders, filling compositions, jointing mortars, grouts or paints.

22. A process for producing starch hybrid copolymers in the form of aqueous dispersions or water-redispersible powders, comprising:
obtaining said starch hybrid copolymers by radically initiated polymerization, more particularly by emulsion polymerization, in aqueous medium of ethylenically unsaturated monomers in the presence of starch and optional subsequent drying, wherein ≥20 wt %, based on the total dry weight of the starch and the ethylenically unsaturated monomers, of cold-water-soluble starch is introduced and as ethylenically unsaturated monomers 50 to 98 wt % of one or more vinyl esters, 1 to 40 wt % of ethylene, 0.1 to 10 wt % of one or more functional monomers, and optionally one or more further ethylenically unsaturated monomers are used; and
wherein the one or more functional monomers are ethylenically unsaturated and carry one or more epoxy, silane and/or N-methylol groups; and
wherein the wt % figures for the monomers are based on the total weight of the monomers.

23. The process of claim 22, wherein the starch hybrid copolymers obtained are used as binders for coating compositions or adhesive bonding compositions, more particularly for paints, textiles, paper or carpets.

24. The process of claim 22, wherein the starch hybrid copolymers obtained are used in leveling compositions, construction adhesives, tile adhesives, adhesives for external wall insulation systems, renders, filling compositions, jointing mortars, grouts or paints.
